(19) United States
(12) Patent Application Publication
(10) Pub. No.: US 2014/0173982 A1
(43) Pub. Date: Jun. 26, 2014

(54) COMBINATIONAL PLANT POT

(71) Applicant: Yueh-Chun KAKU LU, Taipei City (TW)

(72) Inventor: Yueh-Chun KAKU LU, Taipei City (TW)

(21) Appl. No.: 13/726,736

(22) Filed: Dec. 26, 2012

(51) Int. Cl. A01G 9/02

(52) U.S. Cl. CPC A01G 9/02
USPC 47/66.1

(57) ABSTRACT

A combinational plant pot has a base panel and multiple side panels. The side panels are perpendicularly mounted around the base panel. Each side panel has multiple buckling seats separately disposed along a first side edge of the side panel, and multiple resilient buckling plates separately disposed along a second side edge of the side panel and respectively mounted through and engaging the buckling seats of an adjacent side panel. The combinational plant pot can be disassembled when for sale or when not in use. The base panel and the side panels that are disassembled can be stacked to reduce space that the combinational plant pot occupies for the convenience of transportation and storage.

### BACKGROUND OF THE INVENTION

1. Field of the Invention

The present invention relates to a plant pot, especially to a combinational plant pot that is formed by combining a base panel and multiple side panels.

2. Description of the Prior Art(s)

A plant pot is a container in which flowers and other plants are cultivated and displayed. Conventional plant pots are integrally made from clay, plastic, glass, and so forth, and made into different shapes and sizes. Substantially, one conventional plant pot has a mounting recess. The mounting recess is formed in a top surface of the conventional plant pot and receives cultivating media in order to cultivate plants. However, since each of the conventional plant pots is integrally formed as a single part and has a fixed shape, the conventional plant pots occupy quite a large space during transportation or in storage. A user can only stack the conventional plant pots, such as putting one conventional plant pot with smaller size into another conventional plant pot with larger size, so as to reduce the space that the conventional plant pots occupy to the possible minimum, which is troublesome and inconvenient.

To overcome the shortcomings, the present invention provides a combinational plant pot to mitigate or obviate the aforementioned problems.

### SUMMARY OF THE INVENTION

The main objective of the present invention is to provide a combinational plant pot. The combinational plant pot has a base panel and multiple side panels. The side panels are perpendicularly mounted around the base panel. Each side panel has multiple buckling seats separately disposed along a first side edge of the side panel, and multiple resilient buckling plates separately disposed along a second side edge of the side panel and respectively mounted through and engaging the buckling seats of an adjacent side panel.

The combinational plant pot can be disassembled when for sale or when not in use. The base panel and the side panels that are disassembled can be stacked to reduce space that the combinational plant pot occupies for the convenience of transportation and storage.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a combinational plant pot in accordance with the present invention;

FIG. 2 is an exploded perspective view of the combinational plant pot in FIG. 1;

FIG. 3 is an exploded perspective view of a base panel and a side panel of the combinational plant pot in FIG. 1;

FIG. 4 is a perspective view of the base panel and the side panel of the combinational plant pot in FIG. 3;

FIG. 5 is an exploded perspective view of two side panels of the combinational plant pot in FIG. 1; and

FIG. 6 is a perspective view of the two side panels of the combinational plant pot in FIG. 5.

### DETAILED DESCRIPTION OF THE PREFERRED EMBODIMENTS

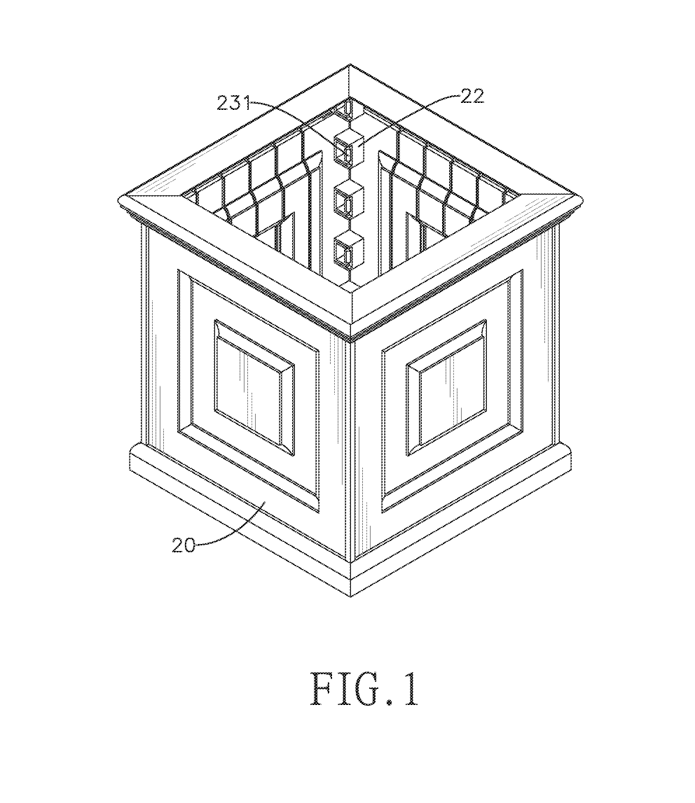

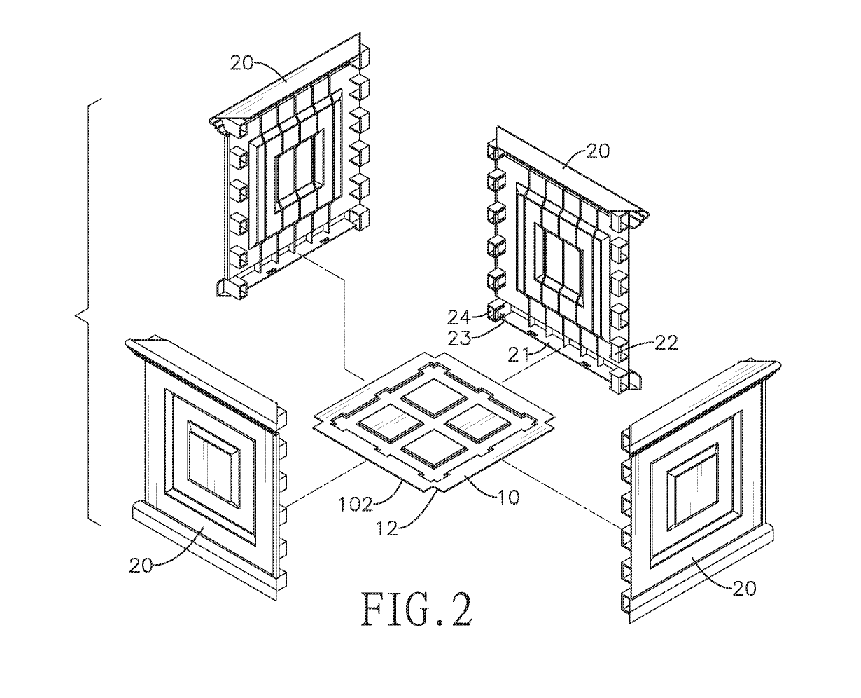

With reference to FIGS. 1 and 2, a combinational plant pot in accordance with the present invention comprises a base panel 10 and multiple side panels 20.

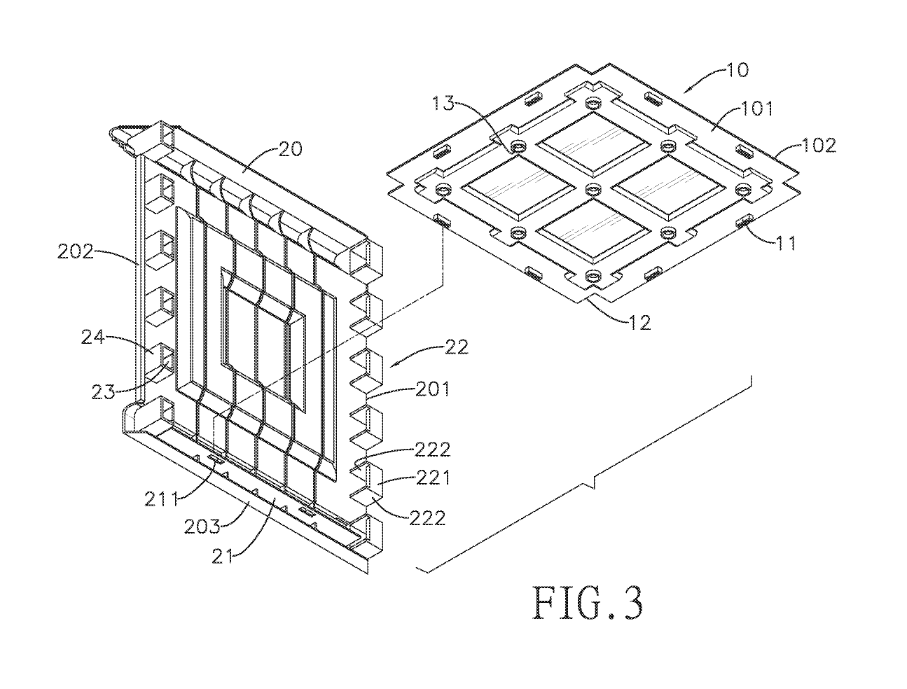

With further reference to FIG. 3, the base panel 10 is polygonal and has a bottom surface 101, a peripheral edge 102, multiple first positioning portions 11, multiple engaging recesses 12 and multiple supporting feet 13. The first positioning portions 11 are separately arranged around the peripheral edge 102 of the base panel 10. The engaging recesses 12 are separately formed in the peripheral edge 102 of the base panel 10. The supporting feet 13 are separately formed on the bottom surface 101 of the base panel 10.

Preferably, the base panel 10 is rectangular and the peripheral edge 102 of the base panel 10 has four corners. The engaging recesses 12 are respectively formed in the corners of the rectangular base panel 10.

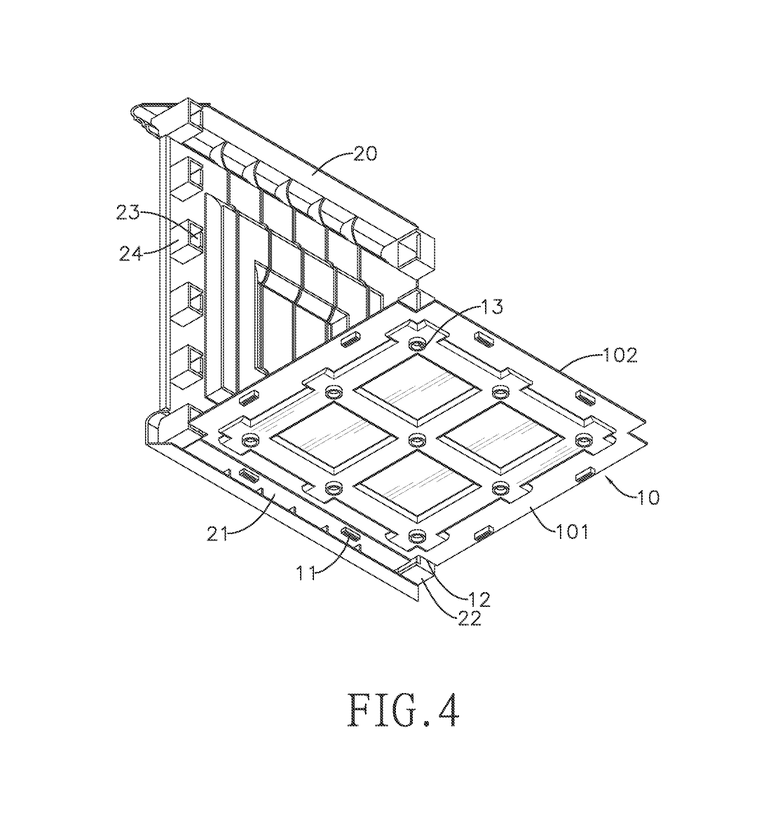

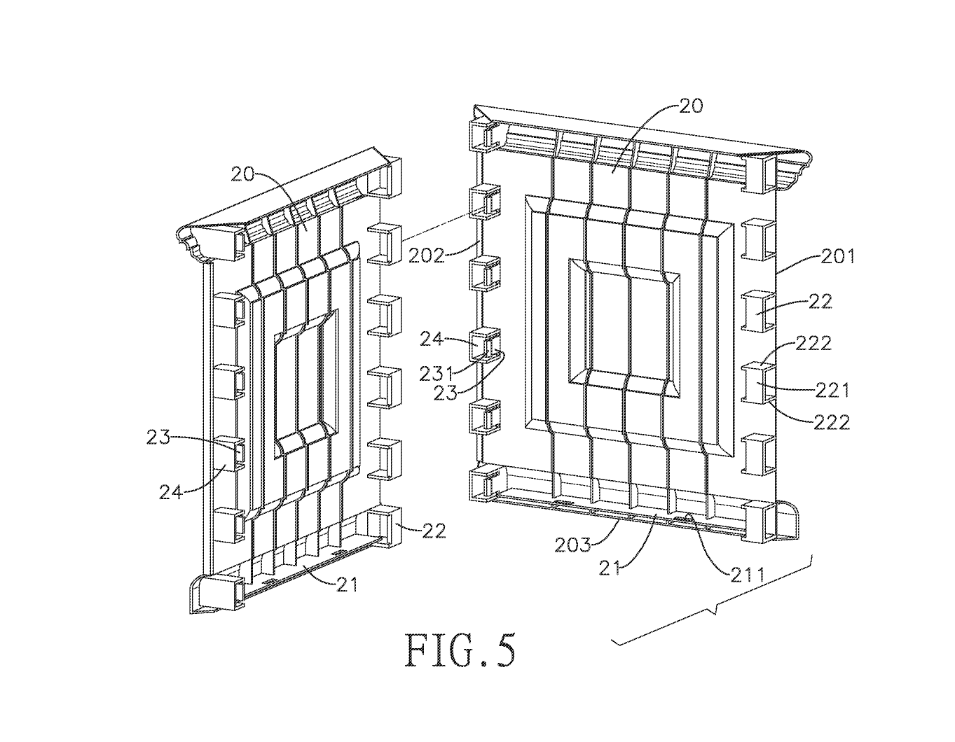

With further reference to FIGS. 4 and 5, the side panels 20 are perpendicularly mounted around the base panel 10. Each side panel 20 is mounted between two of the engaging recesses 12 that are adjacent to each other and has a first side edge 201, a second side edge 202, a bottom edge 203, an inner surface, a positioning fin 21, multiple buckling seats 22, multiple resilient buckling plates 23 and multiple holding seats 24.

The second side edge 202 of the side panel 20 corresponds to and is connected to the first side edge 201 of an adjacent side panel 20.

The positioning fin 21 is elongated, is formed on and transversely protrudes from the inner surface of the side panel 20, extends parallel to the bottom edge 203 of the side panel 20, is mounted below the base panel 10 and has multiple second positioning portions 211. The second positioning portions 211 are separately formed on the positioning fin 21, and respectively correspond to and are respectively connected to the first positioning portions 11 of the base panel 10. The bottom edge 203 of the side panel 20 is flush with the supporting feet 13 of the base panel 10. Thus, the combinational plant pot is stably placed on a plane.

Preferably, the second positioning portions 211 of the positioning fins 21 of the side panels 20 are through holes. The first positioning portions 11 of the base panel 10 are protrusions. The protrusions of the base panel 10 protrude down from the bottom surface 101 of the base panel 10, and are respectively mounted through and engage the through holes of the positioning fins 21 of the side panels 20. Thus, the base panel 10 and the side panels 20 are held in specific relative positions.

The buckling seats 22 are formed on the inner surface of the side panel 20 and are separately disposed along the first side edge of the side panel 20. One of the buckling seats 22 that is disposed most adjacent to the bottom edge 203 of the side panel 20 engages a corresponding engaging recess 12 of the base panel 10. Each buckling seat 22 is U-shaped and has an engaging portion 221 and two extension portions 222. The engaging portion 221 is spaced from the inner surface of the side panel 20 and has an upper edge, a lower edge and an inner edge. The extension portions 222 respectively protrude from the upper edge and the lower edge of the engaging portion 221 and are attached to the inner surface of the side panel 20.

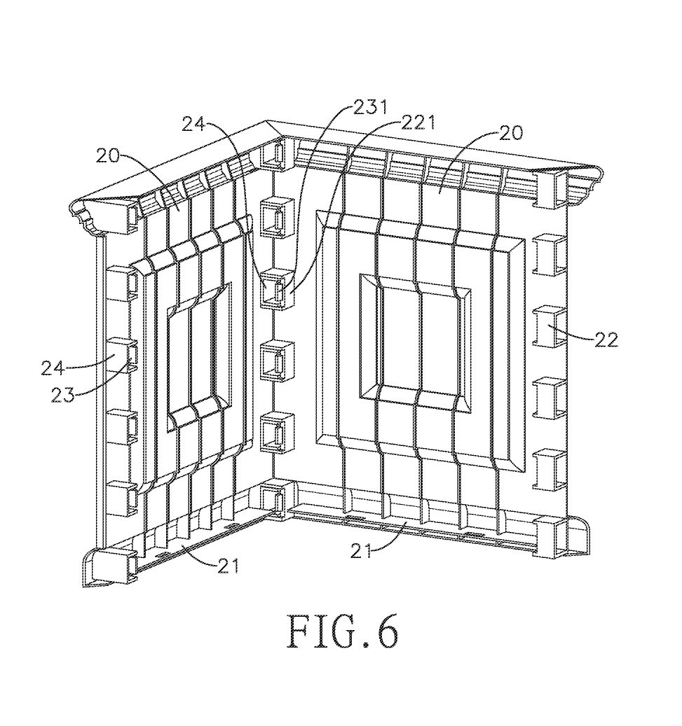

With further reference to FIG. 6, the resilient buckling plates 23 protrude from the inner surface of the side panel 20, are separately disposed along the second side edge 202 of the side panel 20, and are respectively mounted through and engage the buckling seats 22 of the adjacent side panel 20. Each resilient buckling plate 23 abuts the engaging portion 221 of a corresponding buckling seat 22 and has a distal edge and an engaging portion 231. The engaging portion 231 of the resilient buckling plate 23 is formed on the distal edge of the resilient buckling plate 23 and engages the inner edge of the engaging portion 221 of the corresponding buckling seat 22. Thus, each two adjacent side panels 20 are connected to each other.

The holding seats 24 are formed on the inner surface of the side panel 20 and are respectively disposed beside the resilient buckling plates 23. Each holding seat 24 is disposed between a corresponding resilient buckling seat 23 and the second side edge 202 of the side panel 20, is mounted through the corresponding resilient buckling seat 23 and abuts the extension portions 222 of the corresponding resilient buckling seat 23. Thus, each two adjacent side panels 20 are stably connected securely to each other.

The combinational plant pot as described is formed by combining one base panel 10 and multiple side panels 20 and thus can be disassembled when for sale or when not in use. Consequently, the base panel 10 and the side panels 20 that are disassembled can be stacked to reduce space that the combinational plant pot occupies for the convenience of transportation and storage.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A combinational plant pot comprising
a base panel; and
multiple side panels perpendicularly mounted around the base panel, and each side panel having
a first side edge;
a second side edge corresponding to and connected to the first side edge of an adjacent side panel;
a bottom edge;
an inner surface;
a positioning fin formed on and transversely protruding from the inner surface of the side panel, extending parallel to the bottom edge of the side panel and mounted below the base panel;
multiple buckling seats formed on the inner surface of the side panel and separately disposed along the first side edge of the side panel; and
multiple resilient buckling plates protruding from the inner surface of the side panel, separately disposed along the second side edge of the side panel, and respectively mounted through and engaging the buckling seats of the adjacent side panel.

2. The combinational plant pot as claimed in claim 1, wherein each buckling seat has
an engaging portion spaced from the inner surface of the side panel and having an upper edge, a lower edge and an inner edge; and
two extension portions respectively protruding from the upper edge and the lower edge of the engaging portion and attached to the inner surface of the side panel; and
each resilient buckling plate has
a distal edge; and
an engaging portion formed on the distal edge of the resilient buckling plate and engaging the inner edge of the engaging portion of the corresponding buckling seat.

3. The combinational plant pot as claimed in claim 2, wherein each side panel further has multiple holding seats formed on the inner surface of the side panel and respectively disposed beside the resilient buckling plates, and each holding seat is disposed between a corresponding resilient buckling seat and the second side edge of the side panel, is mounted through the corresponding resilient buckling seat and abuts the extension portions of the corresponding resilient buckling seat.

4. The combinational plant pot as claimed in claim 1, wherein
the base panel has a peripheral edge and multiple first positioning portions separately arranged around the peripheral edge of the base panel; and
the positioning fin of each side panel has multiple second positioning portions separately formed on the positioning fin, and respectively corresponding to and respectively connected to the first positioning portions of the base panel.

5. The combinational plant pot as claimed in claim 2, wherein
the base panel has a peripheral edge and multiple first positioning portions separately arranged around the peripheral edge of the base panel; and
the positioning fin of each side panel has multiple second positioning portions separately formed on the positioning fin, and respectively corresponding to and respectively connected to the first positioning portions of the base panel.

6. The combinational plant pot as claimed in claim 3, wherein
the base panel has a peripheral edge and multiple first positioning portions separately arranged around the peripheral edge of the base panel; and
the positioning fin of each side panel has multiple second positioning portions separately formed on the positioning fin, and respectively corresponding to and respectively connected to the first positioning portions of the base panel.

7. The combinational plant pot as claimed in claim 4, wherein
the second positioning portions of the positioning fins of the side panels are through holes; and
the first positioning portions of the base panel are protrusions protruding down from a bottom surface of the base panel, and respectively mounted through and engaging the through holes of the positioning fins of the side panels.

8. The combinational plant pot as claimed in claim 5, wherein
the second positioning portions of the positioning fins of the side panels are through holes; and
the first positioning portions of the base panel are protrusions protruding down from a bottom surface of the base panel, and respectively mounted through and engaging the through holes of the positioning fins of the side panels.

9. The combinational plant pot as claimed in claim 6, wherein
the second positioning portions of the positioning fins of the side panels are through holes; and
the first positioning portions of the base panel are protrusions protruding down from a bottom surface of the base panel, and respectively mounted through and engaging the through holes of the positioning fins of the side panels.

10. The combinational plant pot as claimed in claim 7, wherein
the base panel further has multiple engaging recesses separately formed in the peripheral edge of the base panel;
each side panel is mounted between two of the engaging recesses that are adjacent to each other; and
one of the buckling seats that is disposed most adjacent to the bottom edge of the side panel engages a corresponding engaging recess of the base panel.

11. The combinational plant pot as claimed in claim 8, wherein
the base panel further has multiple engaging recesses separately formed in the peripheral edge of the base panel;
each side panel is mounted between two of the engaging recesses that are adjacent to each other; and
one of the buckling seats that is disposed most adjacent to the bottom edge of the side panel engages a corresponding engaging recess of the base panel.

12. The combinational plant pot as claimed in claim 9, wherein
the base panel further has multiple engaging recesses separately formed in the peripheral edge of the base panel;
each side panel is mounted between two of the engaging recesses that are adjacent to each other; and
one of the buckling seats that is disposed most adjacent to the bottom edge of the side panel engages a corresponding engaging recess of the base panel.

13. The combinational plant pot as claimed in claim 10, wherein the base panel further has multiple supporting feet separately formed on the bottom surface of the base panel.

14. The combinational plant pot as claimed in claim 11, wherein the base panel further has multiple supporting feet separately formed on the bottom surface of the base panel.

15. The combinational plant pot as claimed in claim 12, wherein the base panel further has multiple supporting feet separately formed on the bottom surface of the base panel.
